(19) United States
(12) Patent Application Publication
(10) Pub. No.: US 2019/0197492 A1
(43) Pub. Date: Jun. 27, 2019

(54) METHOD OF ALLOCATING A GUEST PASS TO A GUEST AND A SYSTEM THEREOF

(71) Applicant: Wipro Limited, Bangalore (IN)

(72) Inventors: Kamal Sharad Shah, Bangalore (IN); PadmaSekhar Ayyappan, Bangalore (IN); Shravanti Chaudhuri, Bangalore (IN)

(21) Appl. No.: 15/894,588

(22) Filed: Feb. 12, 2018

(30) Foreign Application Priority Data
Dec. 22, 2017 (IN) 201741046393

(51) Int. Cl. G06Q 10/10; G06Q 50/00; G06K 19/06; G06K 19/07

(52) U.S. Cl. CPC G06Q 10/1095; G06Q 50/01; G06K 19/07; G06K 19/06028; G06K 19/06037

(57) ABSTRACT

A method and system are described for allocating a guest pass to a guest a user by a guest-monitoring system. The method includes receiving a conference request from at least one of the guest or one or more hosts to schedule a conference with at least one of the guest and the one or more hosts. Approval of the conference request by at least one of the one or more hosts and the guest is received. A risk-rating of the guest based on at least one of a profile of the one or more hosts, past visit information of the guest, or social network information of the guest is determined. An identification code is generated based on the risk-rating of the guest. The identification code regulates movement of the guest to one or more predefined guest-areas. The method may include allocation of guest pass to the guest.

This application claims the benefit of Indian Patent Application Serial No. 201741046393, filed Dec. 22, 2017, which is hereby incorporated by reference in its entirety.

### FIELD

The present subject matter is related, in general, to guest management system and more particularly, but not exclusively to a method of automatically allocating a guest pass to a guest.

### BACKGROUND

In large organizations, currently a flow of the guest pass/card allocation process is long and tedious. Presently, when one visits an organization as a guest, one has to depend on the host to raise a guest pass request or allocate a guest pass mostly via security personnel. At times, the guest has to wait and often remind the employee to issue a guest pass. There may be delays as the host or a concerned approving authority could be busy with work or not at their desk. This may lead to many hassles for the guest as well as the host who has to take time out of schedule for the approval process or often escort a guest into the organization premises. Thus, the whole guest pass raising and approving process has a long turnaround time and often involving the attention of a host resulting in loss of productive work hours.

The current process also does not have way of risk mitigation by identification of guest. The guests are often escorted while going inside the premises of the organization but are generally free to come out on their own. This may be great security risk as the guest is free to wander in to highly restricted areas as well. Furthermore, in the current process there is no way of tracking the guest inside the campus. The security officials at the entrance gate usually are unaware of how many guests are inside the organization campus. Also, there is currently no means to track how many guests have stayed back in the campus without any official agenda even after the meeting has been accomplished.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, a method of allocating a guest pass to a guest is disclosed. The method includes receiving, by a guest-monitoring server, a conference request from at least one of the guest and one or more hosts to schedule a conference with at least one of the guest and the one or more hosts. The method includes receiving by the guest-monitoring server, approval of the conference request by at least the one or more hosts and the guest. The method further includes determining, by the guest-monitoring server, a risk-rating of the guest based on at least one of a profile of the one or more hosts, past visit information of the guest, or social network information of the guest. The method further includes generating, by the guest-monitoring server, an identification code based on the risk-rating of the guest. The identification code regulates movement of the guest to one or more predefined guest-areas. The method further includes allocating, by the guest-monitoring server, a guest pass with the identification code.

According to embodiments illustrated herein, guest-management server for allocating a guest pass to a guest is disclosed. The guest management server may comprise a processor and a memory communicatively coupled to the processor. The memory may store instructions which may cause the processor to receive a conference request from at least one of the guest and one or more hosts to schedule a conference with at least one of the guest and the one or more hosts. The memory may store instructions that may cause the processor to receive approval of the conference request by at least one of the one or more hosts and the guest. The memory may further store instructions to receive approval of the conference request by at least one of the one or more hosts. The memory may also store instructions to determine a risk-rating of the guest based on at least one of a profile of the one or more hosts, past visit information of the guest, or social network information of the guest. The memory may also store instructions to generate an identification code based on the risk-rating of the guest, wherein the identification code regulates movement of the guest to one or more predefined guest-areas. The memory may also store instructions to allocate a guest pass with the identification code.

Disclosed herein is a non-transitory computer-readable storage medium having stored thereon, a set of computer-executable instructions for causing a computer comprising one or more processors to perform steps of receiving a conference request from at least one of the guest and one or more hosts to schedule a conference with at least one of the guest and the one or more hosts. The computer-executable instructions may include instructions to receiving approval of the conference request by at least one of the one or more hosts and the guest. The computer-executable instructions may also include instruction to determine a risk-rating of the guest based on at least one of a profile of the one or more hosts, past visit information of the guest, or social network information of the guest. The computer-executable instructions may further include instructions to generate an identification code based on the risk-rating of the guest, wherein the identification code regulates movement of the guest to one or more predefined guest-areas. The computer-executable instructions may further include instructions to allocate a guest pass with the identification code.

The foregoing summary is illustrative only and not intended to be limiting in any way. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device and/or system and/or methods in accordance with embodiments of the present subject matter are now described, by way of example only, and with reference to the accompanying figures.

FIG. 1 is a block diagram illustrating an example system environment in which various embodiments of the present disclosure may function.

FIG. 2 is a block diagram illustrating a guest-management server for allocating a guest pass to a guest.

FIG. 3 is a flowchart illustrating a method of allocating a guest pass to a guest.

FIG. 4 is a block diagram illustrating an exemplary computer system for implementing embodiments consistent with the present disclosure.

It should be appreciated by those skilled in the art that any block diagrams herein represent conceptual views of illustrative systems or devices embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods, systems and devices may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and the like indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” or “in some embodiments “does not necessarily refer to the same embodiment.

In a large organization, such as an Information Technology organization, there are designated high security areas offshore delivery centers for projects, innovation labs and the like. Each of these facilities have high security levels compared to common areas like cafeteria, parks, common rooms and the like. In the currently available system, all the visitors or guests are generally given the same access or identity card irrespective of the facility they are visiting. Different visitors may have various perceived threat-levels based on profile, purpose of visit, and specific facility or person they want to visit. In the currently available system, all the visitors irrespective of the locations or type of facility they were visiting are given the same guest pass that may be incapable of providing seamless yet secured and selective access to various facilities depending on a risk-rating of the guest and the host profile.

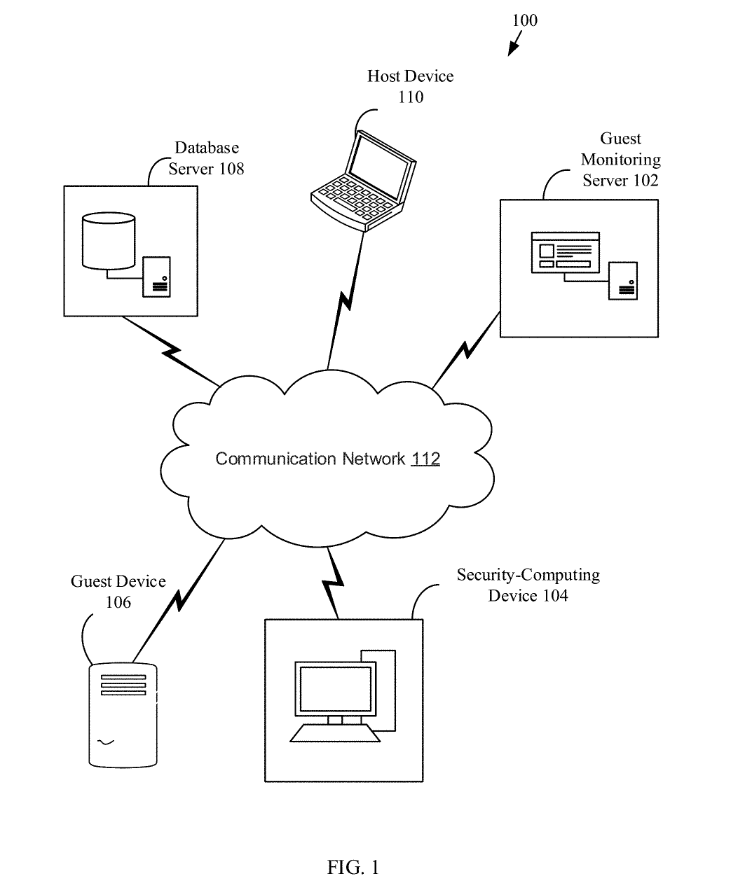

FIG. 1 is a block diagram that illustrates an exemplary environment 100 in which various embodiments of the method may be implemented. The environment 100 may include a guest-monitoring server 102, a security computing device 104, a guest device 106 used by a guest (not shown in the figure), a database server 108, a host device 110 used by a host (not shown in the figure) connected to each other by a communication network 112. It may be noted that in some embodiments, the guest-monitoring server and the security-computing device 104 may be integrated into a single device. Alternatively, the host device 110 may also be integrated to the guest-monitoring server 102 in accordance to some embodiments.

In accordance with some embodiments, communication between the guest-monitoring server 102, the security computing device 104, the guest device 106 used, the database server 108, the host device 110 and various other connected devices maybe performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 112 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

In some embodiments, the guest device 106 and the host device 110 may be a mobile device, a PDA, a laptop, a tablet, a phablet and the like. In some embodiments, the guest device 106 may refer to a computing device used by a guest. Similarly, host device 110 may refer to a computing device used by a host. The guest device 106 and the host device 110 each may comprise of one or more processors and one or more memories. The one or more memories may include computer readable code that may be executable by the one or more processors to perform predetermined operations. In some embodiments, guest device 106 and the host device 110 each may present the user-interface to the user (guest or host) to provide a user input to raise a conference request or accept a conference request. Further, the guest device 106 and the host device 110 each may be configured to receive information pertaining to the conference request.

Similarly, in some embodiments the security-computing device 104 may be a mobile device, a PDA, a laptop, a tablet, a phablet and the like. In some embodiments, the security-computing device 104 may be a device used by security personnel. In some embodiments, the security-computing device 104 may comprise of one or more processors and one or more memories. The one or more memories may include computer readable code that may be executable by the one or more processors to perform predetermined operations. In some embodiments, the security-computing device 104 may present the user-interface to the security personnel to provide an input to raise an alarm, block access or authentication via the identification code assigned to the guest. In some embodiments, under certain pre-defined conditions the security-computing device 104 may be configured may be over-ride the approval or rejection of a conference request raised by a guest or one or more hosts. The security-computing device 104 may be configured to over-ride the automated assignment of the designated regions in the premises of the organization. In an example, when a conference room No. 10 that is usually auto-assigned for interview of a job applicant is under maintenance the security personnel may over-ride the assignment of room No. 10 and reassign a separate room such as conference room No. 20 for the same purpose.

In some embodiments, the guest may use an application installed in the guest device 106 to raise a meeting or conference request with a host via the guest-monitoring server 102. The host may receive a notification for the conference request via guest-monitoring server 102 on the host device 110. In some embodiments, the conference request may be raised by the host via the host-device 110 and approved by the guest via the guest device 106. Alternately, the security-computing device 104 may be able to access the view the notifications and the pending requests. On receiving the conference request from the guest the guest-monitoring server 102 may access information related to the guest from the database server 108 via the communication network 112. In some embodiments, the database server 108 may be integrated to the guest-monitoring server 102 or the security-computing device 104.

In an embodiment, the database server 108 may refer to a computing device that may be configured to store information related to the guest. In an embodiment, the database server 108 may include a special purpose operating system specifically configured to perform one or more database operations on the information related to the guest. Examples of database operations may include, but are not limited to, Select, Insert, Update, and Delete. In an embodiment, the database server 108 may include hardware and/or software that may be configured to perform one or more predetermined operations. In an embodiment, the database server 108 may be realized through various technologies such as, but not limited to, Microsoft® SQL Server, Oracle®, IBM DB2®, Microsoft Access®, PostgreSQL®, MySQL® and SQLite®, and the like.

In some embodiments, the database server 108 may be configured to store one or more guest related information such as biodata of guest, past visit information of the guest, social network information of the guest or any information that may be available publicly on the web related to the guest and the like. In some embodiments, the database server 108 may be configured to store any metadata associated with the guest for further fetching of information pertaining to the guest. The database server 102 may be configured to transmit the information associated with the guest to the guest-monitoring server based on a received request. Similarly, in some embodiments the database server 108 may store information pertaining to the host. The database server 108 may be configured to store any metadata associated with the host for further fetching of information pertaining to the host from one or more sources that may be external to the system 100.

A person with ordinary skill in the art will understand that the scope of the disclosure is not limited to the database server 108 as a separate entity. In an embodiment, the functionalities of the database server 108 can be integrated into the guest-monitoring server 102, and vice versa.

In some embodiments, the guest-monitoring server 102 may refer to a computing device or a software framework hosting an application or a software service. In an embodiment, the guest-monitoring server 102 may be implemented to execute procedures such as, but not limited to, programs, routines, or scripts stored in one or more memories for supporting the hosted application or the software service. In an embodiment, the hosted application or the software service may be configured to perform one or more predetermined operations. The guest-monitoring server 102 may be realized through various types of application servers such as, but are not limited to, a Java application server, a .NET framework application server, a Base4 application server, a PHP framework application server, or any other application server framework.

In some embodiments, the guest-monitoring server 102 may be configured to perform allocation of a guest pass to a guest. The guest-monitoring server 102 may be configured to receive, from the guest via the guest device 106, a conference request to schedule a conference with one or more hosts. The guest-monitoring server 102 may be configured to receive at least one of a biodata and social media details of the guest on receiving a request by the guest to schedule a meeting or a conference with the host. In some embodiments, the biodata and social media details of the guest may be retrieved from the database server 108.

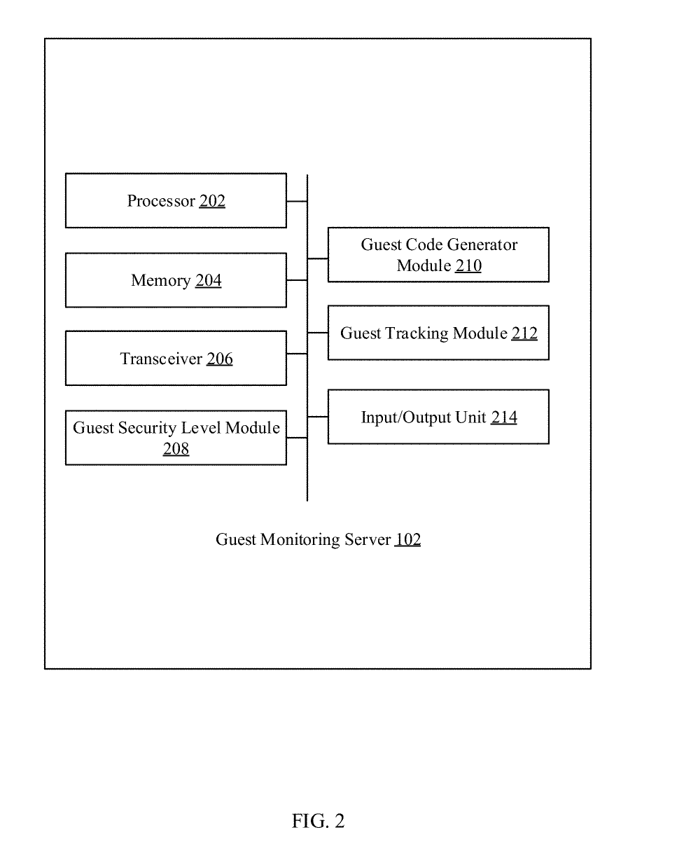

The guest-monitoring server 102 may be configured to perform determination of a risk-rating of the guest based on at least one of a profile of the one or more hosts, past visit information of the guest, or social network information of the guest. The guest-monitoring server 102 may be configured to generate an identification code based on the risk-rating of the guest and the assigned one or more guest-areas, wherein the identification code regulates movement of the guest based on the one or more guest-areas. The guest-monitoring server 102 may be configured to allocate a guest pass to one or more guests with the identification code. In some embodiments, guest-monitoring server 102 may be configured to update the calendar of at least one of the one or more hosts on receiving approval of the conference request by the one or more host. In some embodiments, guest-monitoring server 102 allocation of the guest pass is in the form of at least one of QR code, barcode or monitoring chip. The operation of the guest-monitoring server 102 has been discussed later in conjunction with FIG. 2.

Referring now to FIG. 2, a block diagram of various components within the guest-monitoring server 102 is illustrated, in accordance with an embodiment of the present disclosure. The guest-monitoring server 102 may host application that may be implemented as a variety of portable computing devices, such as, a smartphone, a dedicated handheld device, a tablet, or a phablet. Guest-monitoring server 102 may be also integrated to the security-computing device 104. Alternatively, the guest-monitoring server 102 may be implemented as a distributed system, such that, few components of the guest-monitoring server 102 may reside in a portable device, while, other components may reside in a server, which may be located remotely or integrated to the security-computing device 104.

The guest-monitoring server 102 may include a processor 202, a memory 204, transceiver 208, guest security level module 210, guest code generator module 212, guest tracking module 214, and input/output module 214. Each of the components and modules may be communicatively coupled to each other. It will be appreciated that the above components may be represented as a single module/component or a combination of different modules/components.

The processor 202 comprises suitable logic, circuitry, and interfaces that may be configured to execute a set of instructions stored in the memory 204. The processor 202 may be implemented based on a number of processor technologies known in the art. Examples of the processor 202 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 204 has processor instructions stored thereon, which on execution cause processor 202 to manage system access to a user. The memory 204 may be configured to store one or more programs, routines, or scripts that may be executed in coordination with the processor 202. In some embodiments, the memory 204 includes instructions stored thereon that on execution cause the processor 202 to activate or deactivate, devices used by the user, user accounts, or user access cards. The memory 204 may be implemented based on a Random Access Memory (RAM), a Read-Only Memory (ROM), a Hard Disk Drive (HDD), a storage server, and/or a Secure Digital (SD) card. The memory 204 may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM), and Static Random-Access memory (SRAM).

The guest-monitoring server 102 may include a transceiver 206 as shown in the FIG. 2 to retrieve data from various devices connected to the guest-monitoring server 102. The transceiver 206 comprises suitable logic, circuitry, and interfaces that may be configured to retrieve data pertaining to the guest from external sources such as database server 108. The transceiver may alternatively transmit information from the access management device to other devices communicatively coupled to the guest-monitoring server 102. The transceiver 206 may also transmit control information from the access management device to enable activation or deactivation of one or more devices associated with the user 102. The transceiver 206 may implement one or more known technologies to support wired or wireless communication with the communication network. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer.

The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Text message Service (SMS).

The guest-monitoring server 102 may include a guest-security level module 208 that may collect various parameters associated with the guest from the database server 108. In some embodiments, the guest-security level module 208 may receive bio-data, past visit information and work profile associated with the guest. In some embodiments, the guest-security level module 208 may receive the profile of the one or more hosts associated with the conference request. The bio-data of the guest may include name, age, sex, blood group and disability condition, if any, of the guest. The bio-data associated with the guest may include biometrics and work-profile of the guest. Social network information of the guest may be retrieved from the database server 108. The guest-security level module 208 may receive the profile of the host. The bio-data of the guest, the past visit information and the profile of the host alone or in combination may be the criteria for determining the risk-rating of the guest. In some embodiments, the guest-security level module 208 may determine the designated areas that may be allowed for access by the guest based on the risk-rating of the guest.

The guest-monitoring server 102 may have guest code generator 210 that may be configured to generate unique identification code for each of the guests. In accordance to some embodiments, the guest code generator module 210 may generate the unique identification code for each of the guests based on the risk-ratings of the guest as determined by the guest security level module 208. In some embodiments, guest code generator module 210 may generate the unique identification code for each of the guests based on the determined areas accessible by the guest. The guest code generator 210 may determine the unique identification code for allocation of a guest pass for the guest. The unique identification code may be embedded or incorporated in the form of a QR code, barcode or a chip configured to a security setting based on the risk-rating of the guest and the assigned one or more guest-areas.

In the following non-limiting example, the guest may be a job applicant or a contractor or a client. The guest information such as the bio-data of the guest as provided by the guest or the social network information of the guest that is available may be fetched by the database server 108. In the following Table 1 the host profile information has also been populated for the risk-rating of the guest. Table 1 shows the following information as fed into the guest security level module 208:

TABLE 1

| | | | Guest Past visit/ | | | |
|---|---|---|---|---|---|---|
| | | Guest | security breach | Host | Meeting | Risk- |
| Guest | Host | Information | information/level | Profile | Agenda | rating |
| ABC | TMK | Job | Nil/nil/nil | 1)HR; | Job | MEDIUM |
| | | applicant; 4 | | | interview | |
| | | year work | | | | |
| | | experience; | | | | |
| | | working at | | | | |
| | | competitor | | | | |
| | | company; | | | | |
| MNK | JDM | Client for | 3/1/Low | 1)Team- | Project | HIGH |
| | | confidential | | Lead | related | |
| | | project. | | | | |
| XXT | FLM | Job | 1/0/0 | 1) Manager; | Job | LOW |
| | TMI | Applicant; | | 2) HR | Interview | |
| | | Fresher | | | | |
| IVY | MNI | Contractor | 20/3/Low | 1)Business | Contract | HIGH |
| | | | | Unit Head | renewal | |

TABLE 2

| | Security | | | Time |
|---|---|---|---|---|
| Guest | Level | Host Profile | Area | Allowed |
| ABC | MEDIUM | 1) HR | Cafeteria (2, 3); | 9.15 AM- |
| | | | Play Ground Area; | 5 PM |
| | | | Zone 9; Zone 10; | |
| | | | Conference-Room | |
| | | | No. 10 | |
| MNK | HIGH | 1) Team- | Cafeteria 2; | 12:30 PM- |
| | | Lead | Conference Room | 3.30 PM |
| | | | No. 1; Zone 1; | |
| | | | Zone 2 | |
| XXT | LOW | 1) Manager; | Cafeteria (All); | 9.30 AM- |
| | | 2) HR | Conference Room 14; | 6.00 PM |
| | | | Common Room; | |
| | | | Play Ground Area; | |
| | | | Zone 14 | |
| IVY | HIGH | 1) Business | Conference Room 2; | 11:00 AM- |
| | | Unit Head | Zone 2; Cafeteria 2 | 2:00 PM |

Table 2 shows an exemplary representation of the parameters that may be fed in as an input to the guest security level module 208 for the determination of the designated areas in the premises of the organization that may be allowed access by the guest based on the risk-rating of the guest and the profile of the one or more hosts.

The guest-monitoring server 102 may have a guest-tracking module 212 that may determine location of the guest. The guest-tracking module 212 may detect any unauthorized access of the guest to any area by the guest and send an alert the security. The alert may be received in the security-computing device 104 or by any other means such as beeping of the phone or buzzer or alarm going on at a security room of the organization. The guest-tracking module 212 may alert the guest on the guest device 106 that the guest is at an unauthorized area and specify the areas where the guest is permitted to be present at. In some embodiments, the guest may be assisted to a permitted area from the current location of the guest by the guest-tracking module 212. Alternatively, the guest-tracking module 212 may identify security personnel nearest to the current position of the guest and alert the personnel for assistance to the guest.

Further, the input/output module 214 may display the guest security data, which may include the path traversed by the guest and analytic data pertaining to the time guest when the guest is inside the organization campus. In some embodiments, the input/output module 214 may display the path traversed by the guest, the location of the guest in real time, the proximity of the guest to the host, the time spent by the guest with the host and the like. In some embodiments, the input/output module 214 may be configured to take inputs from the security personnel via the security-computing device 104 or the host via the host device 110.

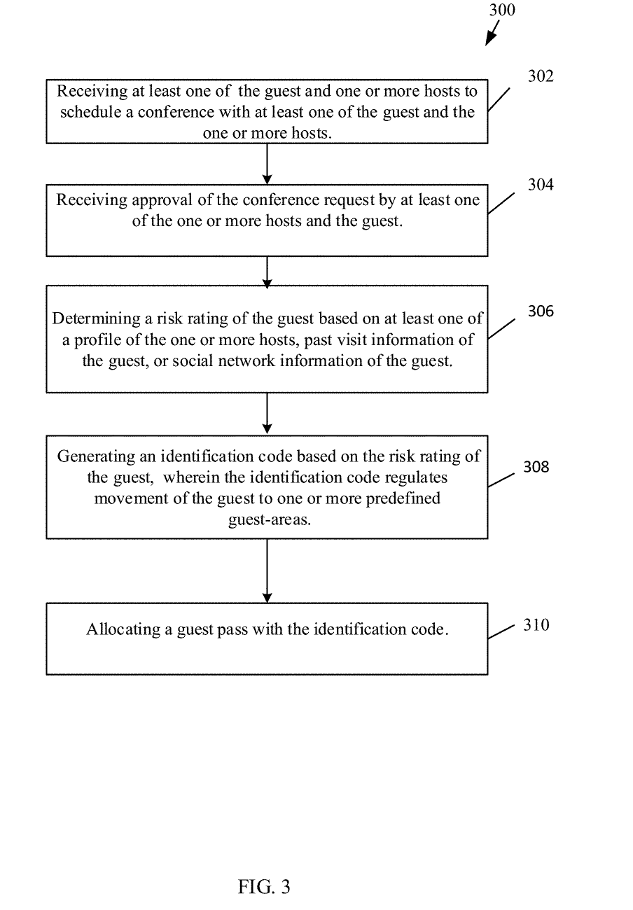

FIG.3 shows a flowchart illustrating a method of allocating a guest pass to a guest, in accordance with some embodiments of the present disclosure. As illustrated in FIG.3, the method 300 includes one or more blocks illustrating a method of allocating a guest pass to a guest, by the guest-monitoring server 102. The method 300 may be described in the general context of computer executable instructions. Generally, computer executable instructions can include routines, programs, objects, components, data structures, procedures, modules, and functions, which perform functions or implement abstract data types. The order in which the method 300 is described is not intended to be construed as a limitation, and any number of the described method blocks can be combined in any order to implement the method 300. Additionally, individual blocks may be deleted from the methods without departing from the spirit and scope of the subject matter described herein. Furthermore, the method 300 can be implemented in any suitable hardware, software, firmware, or combination thereof.

At block 302, the method 300 may include receiving, by the guest-monitoring server 102, a conference request at least one of the guest and one or more hosts to schedule a conference with at least one of the guest and the one or more hosts. In some embodiments, the conference request may include receiving at least one of a biodata and social media details of the guest. In some embodiments, the conference request may be accompanied with at least one of date, time and/or location where the conference may take place.

At block 304, the method may include receiving, by the guest-monitoring server 102, approval of the conference request by at least one of the one or more hosts and the guest. In some embodiments, the approval may be accompanied with at least one of date, time and/or location where the conference may take place. In some embodiments, the calendar of at least one of the one or more hosts and the guest is updated once an approval of the conference request is received.

Further, at block 306, the method may include determining, by the guest-monitoring server 102, a risk-rating of the guest based on at least one of a profile of the one or more hosts, past visit information of the guest, or social network information of the guest. Determination of risk-rating of the guest have been explained in detail in conjunction with FIG. 2.

At block 308, the method may include generating an identification code, by the guest-monitoring server 102, based on the risk-rating of the guest. The identification code may be used to regulate movement of the guest based on the one or more guest-areas. In some embodiments, the identification code may be a QR code, a bar code or alpha-numeric code associated with a monitoring chip and the like. The identification code may restrict access of the guest to only those areas that are specified as per the guest's risk rating. In other words, one or more guest areas may be predefined for a particular risk rating and the identification code implements access to these areas.

At block 310, the guest-monitoring server 102 may allocate the guest pass with the identification code.

The illustrated operations of FIG. 3 and show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

### Computer System

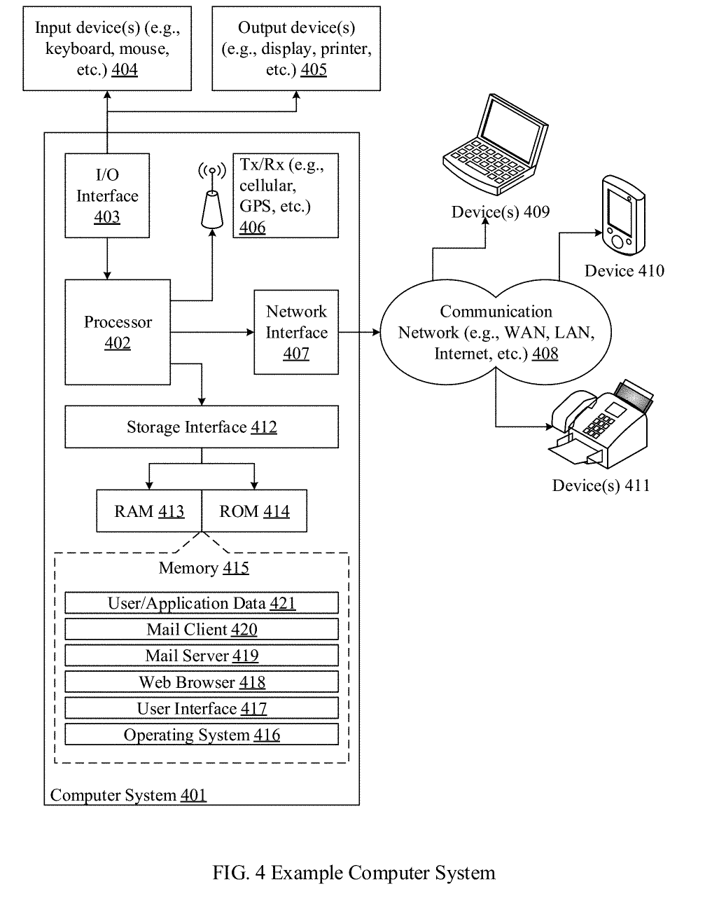

FIG. 4 illustrates a block diagram of an exemplary computer system for implementing embodiments consistent with the present disclosure. Variations of computer system 401 may be used for allocating a guest pass to a guest. The computer system 401 may comprise a central processing unit (“CPU” or “processor”) 402. The processor 402 may comprise at least one data processor for executing program components for executing user-generated or system-generated requests. A user may include a person, a person using a device such as those included in this disclosure, or such a device itself. The processor 402 may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

The processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface 407 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices referred in the FIG. 4 as Memory 415 (e.g., RAM 413, ROM 414, etc.) via a storage interface 412. The storage interface 802 may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OSX, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser 418 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server 419 may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server 419 may utilize communication protocols such as interne text message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client 420 may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described method and device for controlling an autonomous vehicle using location based dynamic dictionary. The illustrated steps are set out to explain the exemplary embodiments shown, and it should be anticipated that ongoing technological development will change the manner in which particular functions are performed. These examples presented herein are for purposes of illustration, and not limitation. Further, the boundaries of the functional building blocks or modules have been arbitrarily defined herein for the convenience of the description. Alternative boundaries or modules can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Examples of the claimed technology are based on managing guest pass allocation and monitoring of guest inside an organization campus. One of a plurality of unique aspects of the claimed technology lies in having a system and method adapted to optimize guest pass allocation with designated accessible areas inside an organization campus based on guest's risk-rating. The method and system disclosed herein is adapted to categorize visitors or guests into different buckets on the basis of risk-factor associated with them and past visit information and the employee or designated host with whom the conference or meeting may take place. The advantage of the invention lies from the fact that each of the guests are allocated a unique identification code and allotted a meeting space based on the risk associated with them. In some embodiments this system is capable of assisting the guest to the designated conference area or room without requiring the host to attend to the guest right from security gate. Examples of this technology also enable issuance of specific cards with different levels of security for different categories of visitors. Further, the method allows the guest to be tracked by the security personnel from his console. Additionally, the guest passes are reusable and can be used again for new visitors by generating a new code.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The terms “a”, “an” and “the” mean “one or more”, unless expressly specified otherwise.

A description of an embodiment with several components or modules in communication with each other does not imply that all such components are required. On the contrary, a variety of optional components or modules are described to illustrate the wide variety of possible embodiments of the invention.

The language used in the specification has been principally selected for readability and instructional purposes, and it may not have been selected to delineate or circumscribe the inventive subject matter. It is therefore intended, that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the devices, systems, modules, and sub-modules have been illustrated and explained to serve as examples and should not be considered limiting in any manner. It will be further appreciated that the variants of the above disclosed device elements, system elements, modules, and other features and functions, or alternatives thereof, may be combined to create other different devices, systems or applications.

Those skilled in the art will appreciate that any of the aforementioned steps, device modules and/or system modules may be suitably replaced, reordered, or removed, and additional steps, device modules and/or system modules may be inserted, depending on the needs of a particular application. In addition, the system or devices of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method of allocating a guest pass to a guest, the method comprising:
receiving, by a guest-monitoring server, a conference request from at least one of the guest and one or more hosts to schedule a conference with at least one of the guest and the one or more hosts;
receiving, by the guest-monitoring server, approval of the conference request by at least one of the one or more hosts and the guest;
determining, by the guest-monitoring server, a risk-rating of the guest based on at least one of a profile of the one or more hosts, past visit information of the guest, or social network information of the guest;
generating, by the guest-monitoring server, an identification code based on the risk-rating of the guest, wherein the identification code regulates movement of the guest to one or more predefined guest-areas; and
allocating, by the guest-monitoring server, a guest pass with the identification code.

2. The method as claimed in claim 1, further comprising updating the calendar of at least one of the one or more hosts and the guest on approval of the conference request by at least the one or more hosts and the guest.

3. The method as claimed in claim 1, wherein the risk rating of the guest is determined based on at least one of a biodata and social media details of the guest.

4. The method as claimed in claim 1, wherein the risk rating of the guest is determined based on at least one of date, time or location.

5. The method as claimed in claim 1, wherein the guest pass is at least one of a QR code, a barcode or a monitoring chip.

6. A guest-monitoring server for allocating a guest pass to a guest, the guest-monitoring server comprising:
a processor; and
a memory communicatively coupled to the processor, wherein the memory stores processor instructions, which, on execution, causes the processor to:
receive a conference request from at least one of the guest or one or more hosts to schedule a conference with at least one of the guest and the one or more hosts;
receive approval of the conference request by at least one of the one or more hosts and the guest;
determine a risk-rating of the guest based on at least one of a profile of the one or more hosts, past visit information of the guest, or social network information of the guest;
generate an identification code based on the risk-rating of the guest, wherein the identification code regulates movement of the guest to one or more predefined guest-areas; and
allocate a guest pass with the identification code.

7. The guest-monitoring server as claimed in claim 6, further comprising updating the calendar of at least one of the one or more hosts and the guest on approval of the conference request by at least the one or more hosts and the guest.

8. The guest-monitoring server as claimed in claim 6, wherein the risk rating of the guest is determined based on at least one of a biodata and social media details of the guest.

9. The guest-monitoring server as claimed in claim 6, wherein the risk rating of the guest is determined based on at least one of date, time or location.

10. The guest-monitoring server as claimed in claim 6, wherein the guest pass is at least one of a QR code, a barcode or a monitoring chip.

11. A non-transitory computer-readable storage medium having stored thereon, a set of computer-executable instructions for causing a computer comprising one or more processors to perform steps comprising:
receiving a conference request from at least one of the guest or one or more hosts to schedule a conference with at least one of the guest and the one or more hosts;
receiving approval of the conference request by at least one of the one or more hosts and the guest;
determining a risk-rating of the guest based on at least one of a profile of the one or more hosts, past visit information of the guest, or social network information of the guest;
generating an identification code based on the risk-rating of the guest, wherein the identification code regulates movement of the guest to one or more predefined guest-areas; and
allocating a guest pass with the identification code.

12. The non-transitory computer-readable storage medium as claimed in claim 11, further comprising updating the calendar of at least one of the one or more hosts and the guest on approval of the conference request by at least the one or more hosts and the guest.

13. The non-transitory computer-readable storage medium as claimed in claim 11, wherein the risk rating of the guest is determined based on at least one of a biodata and social media details of the guest.

14. The non-transitory computer-readable storage medium as claimed in claim 11, wherein the risk rating of the guest is determined based on at least one of date, time or location.

15. The non-transitory computer-readable storage medium as claimed in claim 11, wherein the guest pass is at least one of a QR code, a barcode or a monitoring chip.
